(19) United States
(12) Patent Application Publication
(10) Pub. No.: US 2026/0099900 A1
(43) Pub. Date: Apr. 9, 2026

(54) IMAGE INVERSION AND EDITING USING RECTIFIED FLOW NEURAL NETWORKS

(71) Applicant: Google LLC, Mountain View, CA (US)

(72) Inventors: Litu Rout, Austin, TX (US); Yujia Chen, Bellevue, WA (US); Nataniel Ruiz Gutierrez, Brookline, MA (US); Wen-Sheng Chu, San Jose, CA (US)

(21) Appl. No.: 19/349,016

(22) Filed: Oct. 3, 2025

Related U.S. Application Data
(60) Provisional application No. 63/703,196, filed on Oct. 3, 2024.

(51) Int. Cl. G06T 5/60; G06T 11/60

(52) U.S. Cl. CPC G06T 5/60; G06T 11/60

(57) ABSTRACT

Systems and methods for performing image modification. In particular, the system can, using a rectified flow neural network, perform an image inversion and image editing process to generate a modified image that has been modified according to a conditioning input received by the system.

### CROSS REFERENCE TO RELATED APPLICATIONS

This application claims priority to U.S. Provisional Application No. 63/703,196, filed on Oct. 3, 2024. The disclosure of the prior application is considered part of and is incorporated by reference in the disclosure of this application.

### BACKGROUND

This specification relates to processing images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that performs image modification. In particular, the system can receive an original image and a conditioning input that specifies a modification to be applied to the original image and using a rectified flow neural network, can generate a modified image that has been modified according to the conditioning input.

The subject matter described in this specification can be implemented in particular embodiments so as to realize one or more of the following advantages.

Generative neural networks transform random noise into images; their inversion aims to transform images back to structured noise for recovery and editing. Although diffusion models have recently dominated the field of generative modeling for images, their inversion can present faithfulness (e.g., fidelity, or how closely the output image resembles the input image) and editability challenges due to nonlinearities in drift and diffusion. In some cases, state-of-the-art diffusion model inversion approaches rely on training of additional parameters or test-time optimization of latent variables, which can be significantly computationally expensive in practice.

The techniques described in this specification introduce image inversion and modification using a rectified flow neural network for more effective image editing. More specifically, the techniques described in this specification introduce an efficient inversion process for rectified flow neural networks that requires no additional training, latent optimization, prompt tuning or complex attention processors, all while generating an output that maintains faithfulness and editability during subsequent modification of the image. That is, the techniques described in this specification can significantly reduce computational costs and complexity (as compared to many diffusion model techniques that, as described above, require further optimization), while generating an anchor that is highly faithful and easily editable.

Further, the techniques described in this specification utilize two vector fields for rectified flow inversion, interpolating between two competing objectives (e.g., a conditional and unconditional vector field) to make the output realistic while ensuring it is faithful to the input image (even if the input is corrupted in some manner). In this manner, the techniques described in this specification can combine the fidelity and efficiency of a rectified flow neural network with the robustness of traditional stochasticity used by diffusion models.

At a high level, the techniques described in this specification can merge the efficiency, fidelity and editability of image inversion using a rectified flow neural network with the robustness of diffusion models to generate a high quality modified image.

The details of one or more embodiments of the subject matter of this specification are set forth in the accompanying drawings and description below.

Other features, aspects, and advantages of the subject matter will become apparent from the description, drawings, and the claims.

### BRIEF DESCRIPTION OF DRAWINGS

FIG. 1 shows an example system.

FIG. 2 is a diagram that illustrates an example image inversion process of the example system.

FIG. 3 is a diagram that illustrates an example editing process of the example system.

FIG. 4A illustrates the accuracy of the image inversion process performed by the rectified flow neural network.

FIG. 4B illustrates the improvement of image quality of the modified image generated by the example system.

FIG. 4C illustrates the improvement of image faithfulness of the modified image generated by the example system.

FIG. 5 illustrates the improvement in realism and faithfulness of the modified image generated by the example system.

FIG. 6 is a flow diagram of an example process for generating a modified image.

FIG. 7 is a flow diagram of sub-steps of one of the steps of the process of FIG. 6.

FIG. 8 is a flow diagram of sub-steps of one of the steps of the process of FIG. 6.

Like reference numbers and designations in the various drawings indicate like elements.

### DETAILED DESCRIPTION

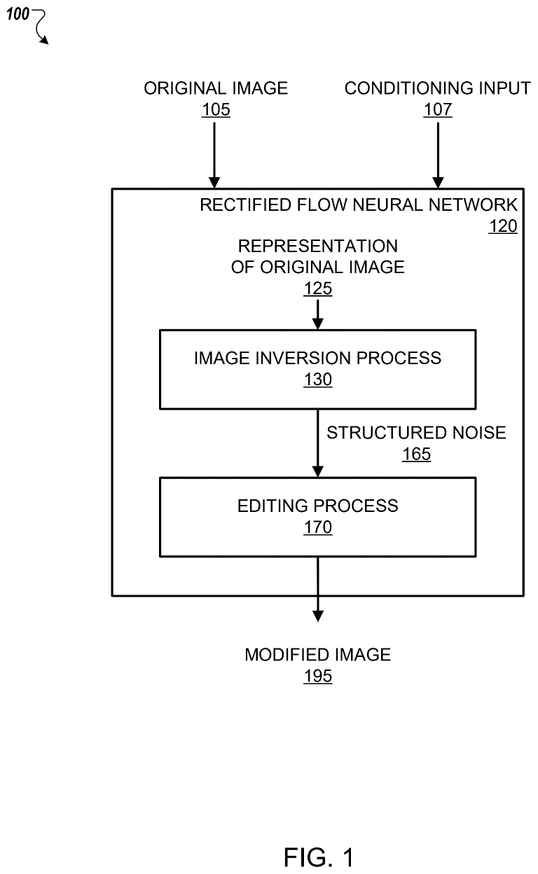

FIG. 1 shows an example system 100 including a rectified flow neural network 120.

The example system 100 is an example of a system implemented as computer programs on one or more computers in one or more locations, in which the systems, components and techniques described below can be implemented.

The system 100 can receive an original image 105 and a conditioning input 107 that specifies a modification to be applied to the original image 105. The system 100 can then generate a modified image 195 using the rectified flow neural network 120 that has been modified according to the conditioning input 107.

The original image 105 can be any type of image and the conditioning input 107 can be any type of conditioning input descriptive of a modification to be applied to the original image 105. For example, the conditioning input 107 can be, e.g., a natural language text or audio input describing the modification or a structured input identifying a class of modification to be applied.

As an example, the original image 105 can be a corrupted image, the conditioning input 107 can specify to remove the corruption, and the modified image 195 can be a clean version of the corrupted image.

As another example, the original image 105 can be an image in one image style, the conditioning input 107 can specify another image style, and the modified image 195 can have the same content as the original image 105 but in the other image style.

As another example, the original image 105 can be an image of a scene, the conditioning input 107 can specify an object to be added to or removed from the scene, and the modified image 195 can be an image of the scene with the specified object removed from or added to the scene.

As another example, the original image 105 can be an image of a scene, the conditioning input 107 can specify one or more properties of an object in the scene to be modified, and the modified image 195 can be an image of the scene with the properties of the object in the scene being modified according to the conditioning input 107.

Any of a variety of other types of modifications are possible. More generally, the system 100 can perform any type of modification that is specified by a given conditioning input 107.

In any of the implementations above, the rectified flow neural network 120 may be deployed as part of image editing software or other software tool (e.g., running on a user device) that receives an input from a user and provides an output to a user in response to the receive input to be displayed to a user on the user device.

This functionality can be implemented by image editing software (e.g., running on a user device) and can be displayed to a user on the user device.

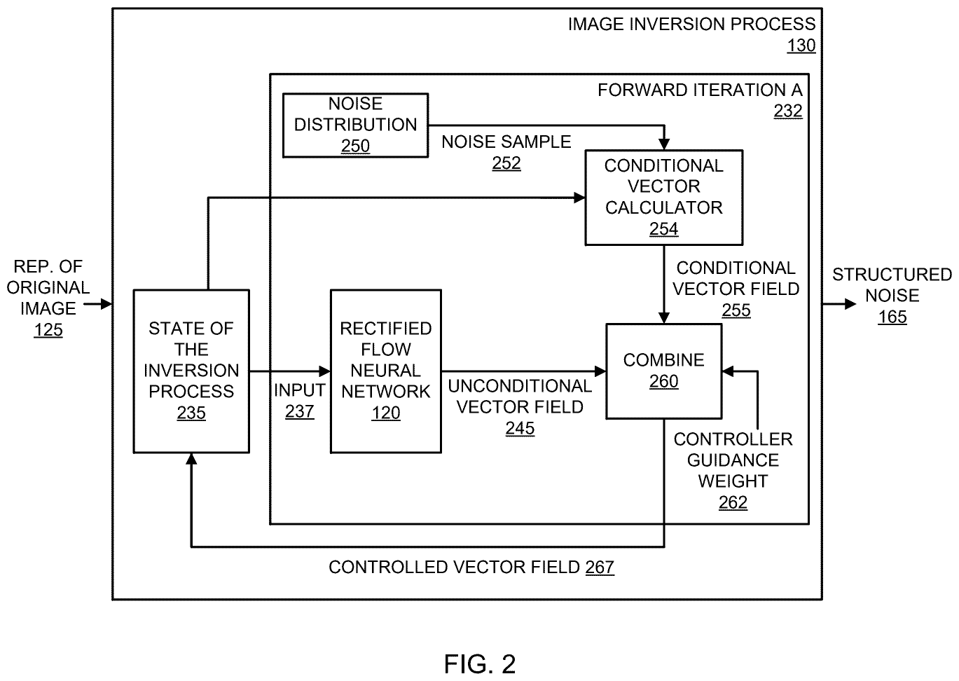

To perform the modification, the system 100 first performs an image inversion process 130 on a representation of the original image 125 using the rectified flow neural network 120 to generate structured noise 165. The structured noise 165 can refer to, for example, a noise vector that is generated by re-noising the original image 125 to encode compositional and semantic details of the original image 125. As described in more detail below with reference to FIG. 2, the structured noise 165 can represent the representation of the original image 125 after the final re-noising step. The system 100 can then perform an editing process 170 using the rectified flow neural network 120 and conditioned on the conditioning input 107 to map the structured noise 165 to a representation of the modified image to generate the modified image 195.

The rectified flow neural network 120 can be any type of generative neural network that is configured to convert noise into complex data by training the neural network to follow the straightest possible path between a noise distribution and a data distribution. That is, the rectified flow neural network 120 can be configured to find a mapping between a complex data distribution and a simple noise distribution such that the movement follows the shortest most efficient possible route (i.e., which is a straight line).

In some implementations, the rectified flow neural network 120 can be a convolutional neural network, e.g., a U-Net or other architecture that maps one input of a given dimensionality to an output of the same dimensionality.

Examples of such rectified flow neural networks include NicheFlow.

As another example, the rectified flow neural network 120 can be a Transformer neural network that processes the original image 105 through a set of self-attention layers to generate the output.

Examples of such rectified flow neural networks include Flux.

As yet another example, the rectified flow neural network 120 can include both convolutional layers and self-attention layers.

The rectified flow neural network 120 can be conditioned on the conditioning input 107 in any of a variety of ways.

As one example, the system 100 can use an encoder neural network to generate one or more embeddings that represent the conditioning input 107 and the rectified flow neural network 120 can include one or more cross-attention layers that each cross-attend into the one or more embeddings.

An embedding, as used in this specification, is an ordered collection of numerical values, e.g., a vector of floating point values or other types of values.

For example, when the conditioning input 107 is text, the system 100 can use a text encoder neural network, e.g., a Transformer neural network, to generate a fixed or variable number of text embeddings that represent the conditioning input 107.

As another example, when the conditioning input 107 is audio, the system 100 can use an audio encoder neural network, e.g., a Transformer neural network, to generate a fixed or variable number of audio embeddings that represent the conditioning input 107. Or, in some implementations, the system 100 can generate a text transcription of the audio and use a text encoder neural network, e.g., a Transformer neural network, to generate a fixed or variable number of text embeddings that represent the conditioning input 107.

In some of these cases, the system 100 can generate one or more initial embeddings for each of the different types of conditioning inputs, i.e., using an appropriate encoder neural network as described above, and then process the initial embeddings for all of the different types of inputs using a Transformer encoder neural network to update each of the initial embeddings to generate a set of final embeddings. The one or more cross-attention layers within the rectified flow neural network 120 can then cross-attend into the set of final embeddings.

In others of these cases, different cross-attention layers within the rectified flow neural network 120 can cross-attend into embeddings of different types of conditioning inputs.

In yet others of these cases, the system 100 can concatenate the initial embeddings of the different types of inputs along the sequence dimension and then the one or more cross-attention layers can cross-attend into the concatenated set of final embeddings.

As another example, the rectified flow neural network 120 can include one or more other types of neural network layers that are conditioned on the one or more embeddings. Examples of such layers include Feature-wise Linear Modulation (FILM) layers, layers with conditional gated activation functions, and so on.

As another example, the output(s) of the encoder(s) when encoding one or more of the conditioning inputs can be combined, e.g., through a weighted sum, with features of the representation of the output image, and the combined features can be processed by the remainder of the rectified flow neural network 120.

In some implementations, the rectified flow neural network 120 can be a pre-trained rectified flow neural network. That is, the rectified flow neural network 120 can be trained on a large dataset of noisy images paired with their corresponding clean target image. In some implementations, the data set can further include the corresponding conditioning input in addition to the pair of images (e.g., the noisy image and clean target image). The rectified flow neural network 120 can be trained on a rectified flow loss function to minimize the difference between the vector field predicted by the rectified flow neural network and the ideal, straight-line vector field. That is, the rectified flow neural network 120 can be trained to learn the shortest, most efficient path for transforming noise into data (or data into noise).

In some implementations, the rectified flow neural network can be pre-trained on a flow matching objective, as seen below, where the loss function (L_{FM} (φ)) minimizes the difference between the target vector field (uₜ(Yₜ)) and the predicted vector field (u(Yₜ, t; φ)):

$${L}_{F M} ( φ ) := {E}_{t ∼ u [ 0 , 1 ] , {Y}_{t} ∼ {p}_{t}} [ {‖ {u}_{t} ( {Y}_{t} ) - u ( {Y}_{t} , t ; φ ) ‖}_{2}^{2} ]$$

As seen in the above equation, for example, the loss function (L_{FM} (φ)) can be a mean squared error (MSE) loss function.

In some implementations, the rectified flow neural network can be pre-trained on a conditional flow matching objective. The conditional flow matching objective can simplify the generation of target vector fields by sampling from one image to learn the flow for one image at a time, conditioned on that image. That is, the conditional flow matching objective can sample one noisy image (Yₜ) and one clean image (Y₁) at a time and calculate a simple, straight-line target vector field between them. The conditional flow matching objective can be seen below, where the loss function (L_{CFM} (φ)) minimizes the difference between the target vector field (uₜ(Y₁)) and the predicted vector field (u(Yₜ, t; φ)):

$${L}_{CFM} ( φ ) := {E}_{t ∼ u [ 0 , 1 ] , {Y}_{t} ∼ {p}_{t} ( \cdot \vert {Y}_{t} ) , {Y}_{1} ∼ {p}_{0}} [ {‖ {u}_{t} ( {Y}_{1} ) - u ( {Y}_{t} , t ; φ ) ‖}_{2}^{2} ]$$

As seen in the above equation, for example, the loss function (L_{CFM} (φ)) can be a mean squared error (MSE) loss function.

In some implementations, the rectified flow neural network 120 performs the editing process 170 and inversion process 130 in pixel space, so that the representations operated on and generated by the rectified flow neural network 120 are images that have values for each pixel that specify color values, e.g., RGB values or another color encoding scheme. That is, in some implementations the representation of the original image 125 is the original image 105 and the representation of the modified image 195 is the modified image.

In some other implementations, the rectified flow neural network 120 performs the editing process 170 and inversion process 130 in latent space, e.g., in a latent space that is lower-dimensional than the pixel space. That is, the representations operated on by the rectified flow neural network 120 are latent images and the values for the pixels of the images are learned, latent values rather than color values.

In these implementations, the rectified flow neural network 120 can be associated with an image encoder to encode images into the latent space and a decoder neural network that receives an input that includes a latent representation of an image and decodes the latent representation to reconstruct the image.

That is, the decoder can be used to process the final representation after the editing process is performed to generate the modified image 195. That is, in some implementations, the rectified flow neural network 120 can generate a representation of the modified image, which is then decoded to generate the modified image 195. Similarly, the encoder can be used to process the original image prior to performing the inversion process to generate the representation of the original image 125 using the rectified flow neural network 120 of the example system 100.

FIG. 2 is a diagram that illustrates an example image inversion process 130 using the rectified flow neural network 120 of the example system 100.

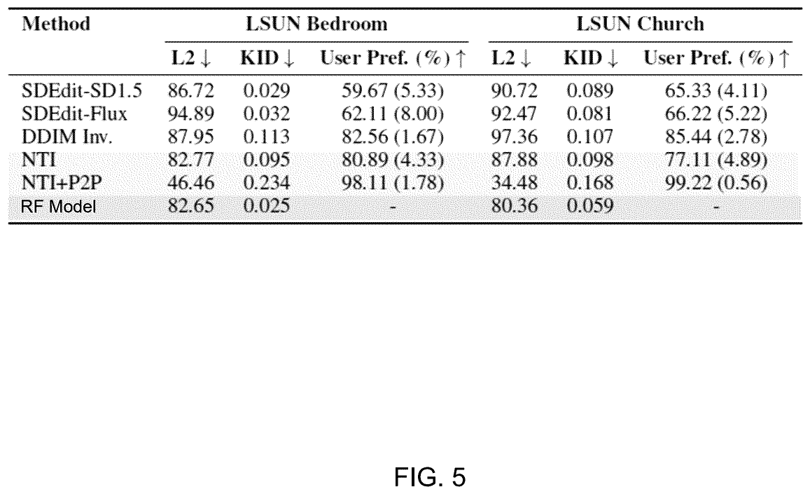

The system 100 can receive a representation of the original image 125 and perform an image inversion process 130 to generate structured noise 165 using the rectified flow neural network 120. That is, the system 100 can receive a representation of the original image 125 and can sequentially re-noise the representation of the original image 125 to generate structured noise 165 that encodes the composition and semantics of the representation of the original image 125. The structured noise 165 can then act as an anchor for image modification during the editing process 170 to maintain faithfulness (e.g., fidelity, or how close the modified image is to the original image). Faithfulness can be measured in any appropriate manner such as, using one or more metrics to compare an original image and a modified image. For example, image faithfulness can be calculated using a PSNR ratio metric or a L2 metric (as seen and further described in FIG. 5).

The system 100 can initialize a state of the inversion process 130 to be the representation of the original image 125. The state of the inversion process 130 can represent, for example, the current representation of the original image 125. That is, the state of the inversion process 130 can represent the progressively re-noised state of the representation of the original image 125 after one or more forward iterations (e.g., re-noising steps) as described in more detail below.

The system 100 can update the state of the inversion process 130 at each of one or more forward iterations, where each forward iteration has a corresponding forward time step. The system 100 can use any number of forward iterations to update the state of the inversion process 130 to generate the structured noise 165. As described above, the state of the inversion process 130 can represent, for example, the re-noised state of the representation of the original image after the one or more forward iterations. In this manner, after the final forward iteration, the system 100 can output the state of the inversion process 235 as the structured noise 165. The forward time step can represent, for example, the size of the re-noising increment per iteration (e.g., how much the state of the inversion process 235 changes during a forward iteration). The corresponding forward time step can be any appropriate time step. In some implementations, the time steps can vary for different forward iterations.

To update the state of the inversion process 235 (e.g., re-noise the representation of the original image 125), at each of one or more forward iterations, the system 100 can generate an unconditional vector field 245 and a conditional vector field 255 and combine the vector fields to generate a controlled vector field 267. For each forward iteration in which the system 100 sequentially re-noises the representation of the original image 125, the system 100 can generate a vector field prediction that is consistent with the original image 125 and a vector field prediction that is consistent with a real image distribution and use the combination of the predictions to update the state of the inversion process 235 to re-noise the representation of the original image 125. That is, the unconditional vector field 245 can represent a prioritization of faithfulness to the original image 125 and the conditional vector field 245 can represent a prioritization of realism (e.g., particularly during denoising/modification). The vector fields can represent, for example, a velocity vector field that represents the direction of re-noising of the representation of the original image 125 along the learned straight trajectory of the rectified flow neural network 120.

In particular, at a forward iteration A 232, the rectified flow neural network 120 can process an input 237 to generate an unconditional vector field 245 for the forward iteration A 232. The input 237 can include the state of the inversion process 235 (e.g., the current representation of the original image 235) and the corresponding time step for the forward iteration A 232. In some implementations, the input 237 can further include a null representation that indicates that the unconditional vector field 245 is not conditioned on a conditioning input (e.g., the conditioning input 107 of FIG. 1). As described above with reference to FIG. 1, the rectified flow neural network 120 can be trained on a training objective to learn the desired vector fields that would map an image from a real data distribution to a noise distribution (e.g., from real data to noise, such as, e.g., structured noise 165)). During inference, the rectified flow neural network 120 can then process the input 237 to generate the unconditional vector field 245.

The system 100 can also generate a conditional vector field 255 for the forward iteration A 232. The system 100 can generate a conditional vector field 255 for the forward iteration A 232 based on a typical noise sample 252 and the state of the inversion process 235. More specifically, the system 100 can determine a difference between the typical noise sample 252 and the state of the inversion process 235 and divide the difference by a divisor that is based on the corresponding forward time step, as seen in the below equation:

$${u}_{t} ( {z}_{t} \vert {y}_{1} ) = ( {y}_{1} - {z}_{t} ) / ( 1 - t )$$

In the above equation, the conditional vector field (uₜ(Zₜ|y₁)) can be computed from dividing the difference between the typical noise sample 252 represented by (Zₜ) and the state of the inversion process 235 represented by (y₁) by a divisor that is (1-t) where t is the corresponding time step.

The noise sample 252 can be any sample from a noise distribution 250. In particular, the noise sample can be any “typical” noise sample, where a “typical” noise sample refers to, for example, a sample from a standard, simple probability distribution. For example, the noise sample can be a sample from a Gaussian distribution.

The system 100 can combine the conditional 255 and unconditional 245 vector fields for the forward iteration A 232 to generate a controlled vector field 267 for the forward iteration A 232. The system 100 can combine the conditional vector field 255 and the unconditional vector field 245 in any appropriate manner. More specifically, in some implementations, the system 100 can combine the conditional vector field 255 and unconditional vector field 245 for the forward iteration A 232 in accordance with a controller guidance weight 262 to generate the controlled vector field 267 for the forward iteration A 232.

To combine the conditional vector field 255 and unconditional vector field 245 for the forward iteration A 232 in accordance with a controller guidance weight 262, the system 100 can use the below equation, where uₜ(Yₜ) represents the unconditional vector field 245, (uₜ(Yₜ|y₁)) represents the conditional vector field 255 and γ represents the controller guidance weight 262:

$${v}_{final} := {u}_{t} ( {Y}_{t} ) + γ ( {u}_{t} ( {Y}_{t} \vert {y}_{1} ) - {u}_{t} ( {Y}_{t} ) )$$

As seen in the above equation, the controlled vector field 267 can be generated by isolating the component of the vector field that is exclusively attributable to the conditioning input 107 by determining the difference between the conditional vector field 255 and the unconditional vector field 245 (e.g., that is not conditioned on the conditioning input). The system 100 can scale the difference by the controller guidance weight 262 to control the influence of the conditioning input 107 on the final vector field. That is, the system 100 can interpolate (e.g., balance) between consistency with the given (possibly corrupted) image and consistency with an image that is consistent with the distribution of images learned by the model. In other words, the system 100 can pull the image towards realism (e.g., during denoising) using the conditional vector field 255 while anchoring the result to the specific content of the input using the unconditional vector field 245 to maintain faithfulness. The scaled difference can then be added back to the unconditional vector field 245 prediction. This ensures that the final vector field has the clarity and focus of the conditioning input without completely losing the structure necessary to produce a realistic, faithful image during the subsequent editing process.

The system 100 can update the state of the inversion process 235 using the controlled vector field 267 for the forward iteration A 232. More specifically, the system 100 can update the state of the inversion process 235 using the controlled vector field 267 for the forward iteration A 232 and corresponding noise levels for the forward iteration A 232 and a subsequent forward iteration.

In particular, the system 100 can determine a difference between the corresponding noise level for the subsequent forward iteration and the corresponding noise level for the forward iteration. That is, the system 100 can calculate the step size for the re-noising process by determining the difference between the current noise level and the next intended noise level. The system 100 can then determine a product of the controlled vector field 267 and the determined difference and add the product to the state of the inversion process 235. That is, the system 100 can generate the distance (or displacement) that the representation of the original image 125 should move during the small interval of time to update the state of the inversion process 235 to sequentially re-noise the representation of the original image 125.

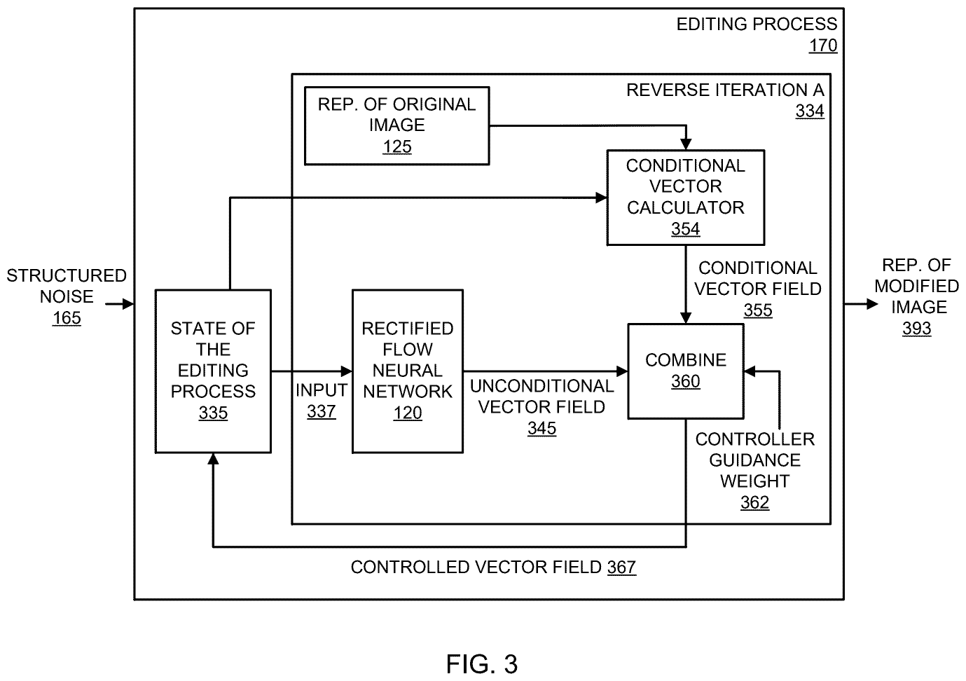

FIG. 3 is a diagram that illustrates an example editing process 170 of the rectified flow neural network 120 of the example system 100.

The system 100 can receive the structured noise 165 and perform an editing process 170 to generate a representation of a modified image 393 using a rectified flow neural network 120. That is, the system 100 can receive the structured noise 165 and can perform an editing process (e.g., reconstruction) to progressively denoise and modify the structured noise 165 to generate a representation of the modified image 393 (which can either represent the modified image 195 or be decoded to generate the modified image 195).

The system 100 can initialize a state of the editing process 335 to be the structured noise 165. Similarly to the state of the inversion process 235 of FIG. 2, the state of the editing process 335 can represent, for example, the current representation of the structured noise 165 during the denoising process. That is, the state of the editing process 335 can represent the de-noised and modified state of the structured noise 165 after one or more reverse iterations (e.g., denoising steps) to progressively denoise the structured noise 165 to generate the modified image (or representation of the modified image 393) as described in more detail below.

The system 100 can update the state of the editing process 170 at each of one or more reverse iterations, where each reverse iteration has a corresponding reverse time step. The system 100 can use any number of reverse iterations to update the state of the editing process 335 to generate the representation of the modified image 393. As described above, the state of the editing process 335 can represent, for example, the de-noised, modified state of the structured noise 165 after the one or more reverse iterations. In this manner, after the final reverse iteration, the system 100 can output the state of the editing process 335 as the representation of the modified image 393 (or in some implementations, the modified image). The reverse time step can represent, for example, the size of the de-noising increment per iteration (e.g., how much the state of the editing process 335 changes during a forward iteration). The corresponding reverse time step can be any appropriate time step. In some implementations, the time steps can vary for different reverse iterations.

To update the state of the editing process (e.g., de-noise the structured noise 165), at each of one or more reverse iterations, the system 100 can generate an unconditional vector field 345 and a conditional vector field 355 and combine the vector fields to generate a controlled vector field 367. That is, for each reverse iteration in which the system 100 progressively de-noises the structured noise 165, the system 100 can generate a vector field prediction that prioritizes faithfulness to the original image (such as, e.g., the original image 125 of FIGS. 1 and 2) and a vector field prediction that prioritizes realism and use the combination of the predictions to update the state of the editing process 335 to de-noise and modify the structured noise 165. The vector fields can represent, for example, a velocity vector field that represents the direction of de-noising and modification of the structured noise 165 along the learned, straight trajectory of the rectified flow neural network 120.

In particular, at a reverse iteration A 334, the rectified flow neural network 120 can process an input 337 to generate an unconditional vector field 345 for the reverse iteration A 334. The input 337 can include the state of the editing process 335, a time step derived from the corresponding reverse time step for the reverse iteration and a representation of the conditioning input. As described above with reference to FIG. 1, the rectified flow neural network 120 can be trained on a training objective to learn the desired vector fields and predict a vector field. During inference, the rectified flow neural network 120 can then process the input 337 to generate the unconditional vector field 245. The unconditional vector field 245 can represent a vector field that follows the trajectory necessary to reconstruct the features of the original image (such as, e.g., original image 125 of FIGS. 1 and 2).

In particular, the time step derived from the corresponding reverse time step for the reverse iteration can be equal to one minus the corresponding reverse time step for the reverse iteration. That is, because the knowledge of the rectified flow neural network 120 was learned in the data-to-noise direction, the time step is one minus the corresponding reverse time step to ensure the time index is for the reverse flow (e.g., noise-to-data direction). Similarly, the unconditional vector field 345 for the reverse iteration A 334 can be a negative of an output of the rectified flow neural network 120 generated by processing the input 337 including the state of the editing process 335, the time step derived from the corresponding reverse time step for the reverse iteration A 334, and the representation of the conditioning input (e.g., the conditioning input 107 of FIG. 1).

The system 100 can also generate a conditional vector field 355 for the reverse iteration A 334. The system 100 can generate a conditional vector field 355 for the reverse iteration A 334 based on the representation of the original image 125 and the state of the editing process 335. More specifically, the system 100 can determine a difference between the representation of the original image 125 and the state of the editing process 335 (e.g., the current state of the denoising process of the structured noise 165) and divide the difference by a divisor that is based on the corresponding reverse time step, as seen in the equation below, where cₜ(Zₜ, t) represents the conditional vector field, y₀ represents the representation of the original image and Zₜ represents the state of the editing process 335:

$${c}_{t} ( {Z}_{t} , t ) = ( {y}_{0} - {Z}_{t} ) / ( 1 - t )$$

The system 100 can combine the conditional vector field 355 and unconditional vector field 345 to generate a controlled vector field 367 for the reverse iteration A 334. The system 100 can combine the conditional vector field 367 and the unconditional vector field 345 in any appropriate manner. More specifically, in some implementations, the system 100 can combine 360 the conditional vector field 355 and the unconditional vector field 345 for the reverse iteration in accordance with a controller guidance weight 362 to generate the controlled vector field 367 for the reverse iteration A 334.

To combine the conditional vector field 355 and unconditional vector field 345 for the forward iteration A 334 in accordance with a controller guidance weight 362, the system 100 can use the below equation, where uₜ(Yₜ) represents the unconditional vector field 345, (uₜ(Yₜ|y₁)) represents the conditional vector field 355 and γ represents the controller guidance weight 362:

$${v}_{final} := {u}_{t} ( {Y}_{t} ) + γ ( {u}_{t} ( {Y}_{t} \vert {y}_{1} ) - {u}_{t} ( {Y}_{t} ) )$$

As seen in the above equation, the controlled vector field 367 can be generated by isolating the component of the vector field that is exclusively attributable to the conditioning input by determining the difference between the conditional vector field 355 and the unconditional vector field 345 (e.g., that is not conditioned on the conditioning input). The system 100 can scale the difference by the controller guidance weight 362 to control the influence of the conditioning input on the final vector field. That is, the system 100 can interpolate (e.g., balance) between consistency with the given (possibly corrupted) image and consistency with an image that is consistent with the distribution of images learned by the model. In other words, the system 100 can pull the image towards realism using the conditional vector field 255 while anchoring the result to the specific content of the input using the unconditional vector field 245 to maintain faithfulness. The scaled difference can then be added back to the unconditional vector field 345 prediction. This ensures that the final movement has the clarity and focus of the conditioning input without completely losing the structure necessary to produce a realistic, faithful image.

In some implementations, the different reverse iterations have different controller guidance weights. For example, the controller guidance can be a time-varying controller guidance. A higher controller guidance weight improves faithfulness but limits editability, while a lower controller guidance weight allows significant edits at the cost of reduced faithfulness.

The system 100 can update the state of the editing process using the controlled vector field 367 for the reverse iteration. More specifically, the system 100 can update the state of the editing process 335 using the controlled vector field 367 for the reverse iteration A 334 and corresponding noise levels for the reverse iteration and a subsequent reverse iteration.

In particular, the system 100 can determine a difference between the corresponding noise level for the subsequent reverse iteration and the corresponding noise level for the reverse iteration. That is, the system 100 can calculate the step size for the de-noising process by determining the difference between the current noise level and the next intended noise level. The system 100 can then determine a product of the controlled vector field 367 and the determined difference and add the product to the state of the editing process 335. That is, the system 100 can generate the distance (or displacement) that the structured noise 165 should move during the small interval of time to update the state of the editing process 335 to complete the de-noising and modification.

In some implementations, the editing process 170 further includes updating the state of the editing process using the unconditional vector field 345. More specifically, the system 100 can update the state of the editing process 335 at each of one or more additional reverse iterations that are after the one or more reverse iterations, each additional reverse iteration having a corresponding additional reverse time step.

To update the state of the editing process 335, the system 100 can process an input including the state of the editing process, a time step derived from the corresponding additional reverse time step for the additional reverse iteration, and the representation of the conditioning input using the rectified flow neural network 120 to generate an unconditional vector field 345 for the additional reverse iteration. The system 100 can update the state of the editing process 335 using the unconditional vector field 345 for the additional reverse iteration. In particular, the system can update the state of the editing process using the unconditional vector field for the additional reverse iteration without generating a conditional vector field for the additional reverse iteration.

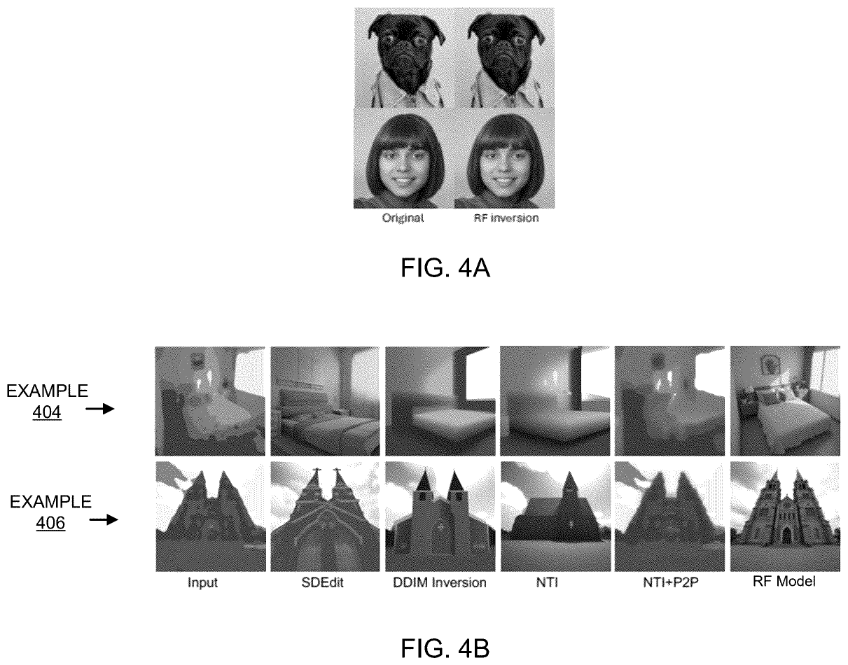

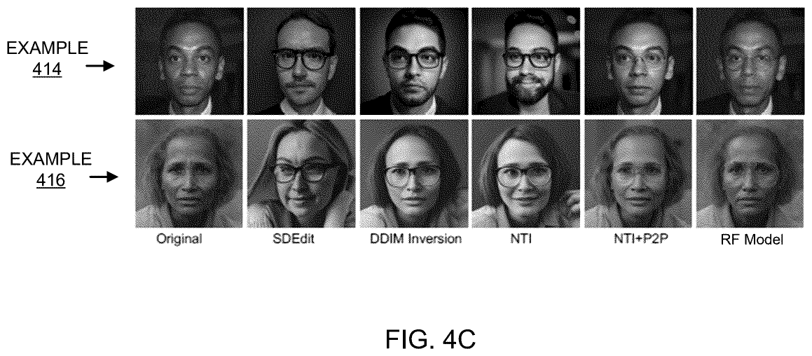

FIGS. 4A-4C visually demonstrate the accuracy and improvement of the inversion and editing processes performed by the example system using the rectified flow neural network (e.g., the rectified flow neural network 120 of FIGS. 1-3).

First, FIG. 4A illustrates the accuracy of the inversion and editing processes performed by the rectified flow neural network to reconstruct an original image.

As described above with reference to FIGS. 1-3, the rectified flow neural network can perform an image inversion process to generate structured noise that is encoded with semantic information about the original image and then perform an editing process to generate a modified image (or in some implementations, reconstruct the original image).

The examples depicted in FIG. 4A highlight the accuracy of the image inversion process to accurately encode the semantic information of the original image for near-perfect reconstruction, demonstrating the strength of the structured noise as an anchor for further image modification (such as, e.g., removing corruption, or adding objects into the scene) to maintain fidelity.

FIG. 4B illustrates the improvement of image quality of a modified image generated by the example system (e.g., the example system 100 of FIGS. 1-3) over traditional methods. More specifically, FIG. 4B demonstrates the robustness of the example system for generation of a photo-realistic image from a corrupted image and a conditioning input descriptive of the desired image scene.

For example, as seen in example 404, the example system can receive a corrupted image (also known as a stroke paint) and a conditioning input (“photo-realistic picture of a bedroom”) and can generate a clean photo-realistic image of a bedroom.

FIG. 4B can further compare the clean, photo-realistic output images of the example system (“RF model”) with one or more traditional diffusion based methods.

A stochastic different editing (SDEdit) method can represent an image modification framework that uses a pre-trained diffusion model without explicit inversion. The SDEdit method can edit a corrupted image by blending user edits and image corruption with random noise to generate the new realistic image. However, as depicted in FIG. 4B, the SDEdit method does not generate as accurate, high quality images as the example system described in this specification. For example 404, while the SDEdit method can generate a photo-realistic image of a bedroom, the modified image lacks the fidelity to the corrupted input image that the modified image generated using the rectified flow neural network described in this specification. Further, for example 406, the SDEdit method generates a blurry, unclear image of a church that is not as faithful to the corrupted input image compared to the modified image of the rectified flow neural network.

A denoising diffusion implicit model (DDIM) inversion method can represent a standard inversion process and subsequent editing process using a diffusion model. As depicted in FIG. 4B, for example 404 and example 406, the DDIM inversion method propagates the corruption from the corrupted image to the structured noise, and the corresponding reverse process initializes, at this noise transfer, the corruption back to the edited image, leading to a blurry unclear image. Additionally, as seen in both example 404 and 406, the generated modified image does not maintain fidelity to the corrupted image either, changing the perspective of objects in the images.

A null-text inversion (NTI) method can represent a specialized optimization method used with a pre-trained diffusion model to generate a noise anchor from the original image to maintain fidelity. As demonstrated in FIG. 4B, the NTI method also converges toward the corrupt image because the NTI method uses optimized null embeddings to align the reverse process with the DDIM forward trajectory (e.g., it faces the same issues as DDIM in that regard). Further, while the NTI method focuses on maintaining fidelity, the modified image generated by the NTI method does not maintain significant fidelity to the corrupted input image.

A prompt-to-prompt (P2P) method can represent a technique used to perform specific, text-guided edits while preserving the global composition. When P2P is added to the NTI pipeline, the P2P method attempts to localize the edits, preserving the unedited parts of the image. However, while this localization is beneficial for clean images, for corrupted images, P2P drives the reverse process even closer to the corruption, leading to an even blurrier, unclear image, but one that maintains a bit more fidelity to the corrupted input image.

In contrast, the methods of the example system as described in this specification, (“RF Model”) can generate a modified image that is clear and high quality while maintaining fidelity to the corrupted input image. By generating structured noise that is consistent with the corrupted image, and using the invariant terminal distribution (e.g., the fixed statistical reference point that allows the rectified flow neural network to learn the vector field that transforms image from the initial distribution to the terminal distribution), the example system can generate a higher-quality more-realistic image.

FIG. 4C illustrates the improvement of image faithfulness of the modified image generated by the example system (e.g., the example system 100 FIGS. 1-3) over traditional methods. More specifically, FIG. 4C demonstrates the balance between faithfulness and editability of the example system for modification of an input image through the addition of a new object in the scene.

For example, as seen in example 414, the example system can receive an original image and a conditioning input (“face of a man wearing glasses”) and can generate a high-quality image of a woman wearing glasses that is faithful to the original image.

FIG. 4C can further compare the modified images of the example system (“RF model”) with one or more traditional diffusion based methods (such as, e.g., the diffusion based methods described above with reference to FIG. 4B).

As depicted in FIG. 4C, while each of the diffusion based methods are able to generate a high-quality modified image, the methods described in this specification using the rectified flow neural network generate a modified image that is the most faithful modified image to the original image for both example 414 and example 416.

FIG. 5 illustrates the improvement in realism and faithfulness of the modified image generated by the example system.

Further to the visuals demonstrated in FIGS. 4A and 4B, as depicted in the table, the method performed by the example system can outperform prior methods in faithfulness and realism according to one or more metrics.

A L2 loss metric can represent the fundamental, pixel-by-pixel metric that measures fidelity between two pieces of data. More specifically, the loss quantifies the average squared distance between every point in a predicted output and the corresponding ground truth input. A lower L2 loss ensures higher fidelity (e.g., that the image reconstructed from the inverted noise is an exact, pixel-for-pixel copy of the original image.

A kernel inception distance (KID) metric can represent a high-level metric used to evaluate the quality and diversity of images generated by a model, comparing the distribution of the generated images to the distribution of real images to capture realism. A lower KID indicates that the generated images are statistically very similar to the real training images in terms of visual quality, color, and texture. As seen in the test split for the bedroom dataset (e.g., example 404 of FIG. 4B), the approach described in this specification is 4.7% more faithful and 13.79% more realistic than the best optimization free method of SDEdit and 73% more realistic than the optimization based method NTI.

Additionally, the table depicts the percentage of users that prefer to use the method described in this specification over each alternative in pairwise comparisons. For all the methods, the majority of users (+50%) preferred to use the method described in this specification.

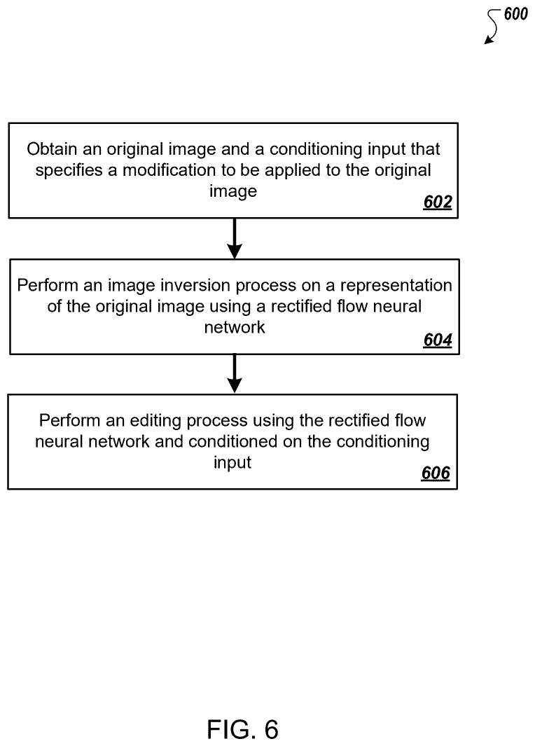

FIG. 6 is a flow diagram of an example process for generating a modified image.

For convenience, the process 600 will be described as being performed by a system of one or more computers located in one or more locations. For example, a system, e.g., the system 100 depicted in FIG. 1, appropriately programmed in accordance with this specification, can perform the process 600.

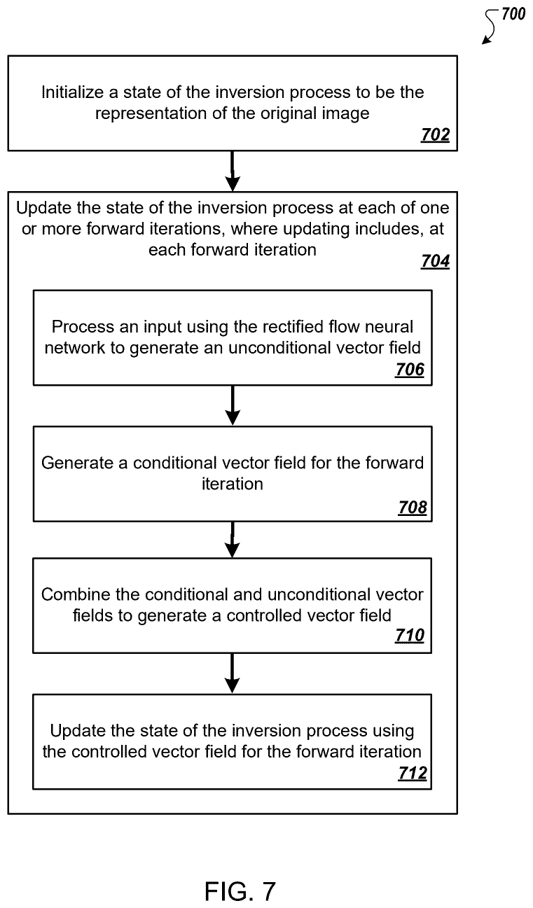

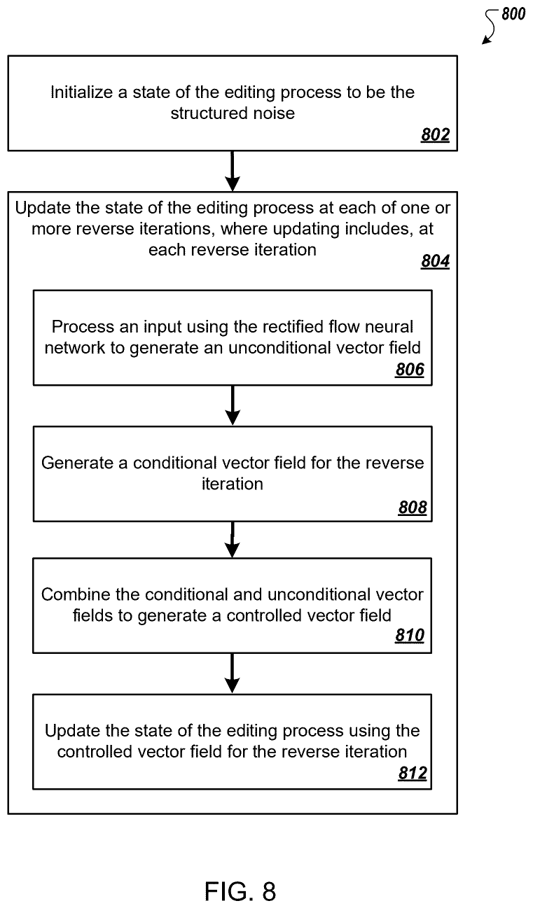

The system can obtain an original image and a conditioning input that specifies a modification to be applied to the original image (602).
The system can perform an image inversion process on a representation of the original image using a rectified flow neural network to generate structured noise (604). In some implementations, the representation of the original image is the original image. In some implementations, the process 600 can further include processing the original image using an encoder neural network to generate the representation of the original image. The image inversion process is described in further detail below with reference to FIG. 7.
The system can perform an editing process using the rectified flow neural network and conditioned on the conditioning input to map the structured noise to a representation of a modified image (606). In some implementations, the representation of the modified image is the modified image. In some implementations, the process 600 can further include processing the representation of the modified image using a decoder neural network to generate the modified image. The editing process is described in further detail below with reference to FIG. 8.

FIG. 7 is a flow diagram of sub-steps of step 604 of the process 600 of FIG. 6.

For convenience, the process 700 will be described as being performed by a system of one or more computers located in one or more locations. For example, a system, e.g., the system 100 depicted in FIG. 1, appropriately programmed in accordance with this specification, can perform the process 700.

As described above, the process 700 is a subprocess of the step 604 of the process 600 that details an example image inversion process of the system.

The system can initialize a state of the inversion process to be the representation of the original image (702).

The system can update the state of the inversion process at each of one or more forward iterations, each forward iteration having a corresponding forward time step (704).

Steps 706-712 are sub-steps of the step 704 and further describe the updating process at each forward iteration.
The system can process an input including the state of the inversion process and the corresponding forward time step for the forward iteration using the rectified flow neural network to generate an unconditional vector field for the forward iteration (706). In some implementations, the input including the state of the inversion process and the corresponding forward time step for the forward iteration further includes a null representation that indicates that the unconditional vector field is not conditioned on a conditioning input.
The system can generate a conditional vector field for the forward iteration (708). In some implementations, generating a conditional vector field for the forward iteration includes generating the conditional vector field based on a typical noise sample and the state of the inversion process. More specifically, the system can determine a difference between the typical noise sample and the state of the inversion process and divide the difference by a divisor that is based on the corresponding forward time step. In some implementations, the typical noise sample is a sample from a noise distribution. In some implementations, the noise distribution is a Gaussian distribution.
The system can combine the conditional and unconditional vectors fields for the forward iteration to generate a controlled vector field for the forward iteration (710). In some implementations, combining the conditional and unconditional vector fields for the forward iteration to generate a controlled vector field for the forward iteration includes combining the conditional and unconditional vector fields for the forward iteration in accordance with a controller guidance weight to generate the controlled vector field for the forward iteration.
The system can update the state of the inversion process using the controlled vector field for the forward iteration (712). In some implementations, updating the state of the inversion process using the controlled vector field for the forward iteration includes updating the state of the inversion process using the controlled vector field for the forward iteration and corresponding noise levels for the forward iteration and a subsequent forward iteration. More specifically, the system can determine a difference between the corresponding noise level for the subsequent forward iteration and the corresponding noise level for the forward iteration, determine a product of the controlled vector field and the difference and add the product to the state of the inversion process.

FIG. 8 is a flow diagram of sub-steps of step 606 of the process 600 of FIG. 6.

For convenience, the process 800 will be described as being performed by a system of one or more computers located in one or more locations. For example, a system, e.g., the system 100 depicted in FIG. 1, appropriately programmed in accordance with this specification, can perform the process 800.

As described above, the process 800 is a subprocess of the step 606 of the process 600 that details an example editing process of the system.

The system can initialize a state of the editing process to be the structured noise (802).

The system can update the state of the editing process at each of one or more reverse iterations, each reverse iteration having a corresponding reverse time step (804).

Steps 806-812 are sub-steps of the step 804 and further describe the updating process at each reverse iteration.
The system can process an input including the state of the editing process and the corresponding reverse time step for the reverse iteration using the rectified flow neural network to generate an unconditional vector field for the reverse iteration (806). In some implementations, the time step derived from the corresponding reverse time step for the reverse iteration is equal to one minus the corresponding reverse time step for the reverse iteration. In some implementations, the unconditional vector field for the reverse iteration is a negative of an output of the rectified flow neural network generated by processing the input including the state of the editing process, the time step derived from the corresponding reverse time step for the reverse iteration, and the representation of the conditioning input.
The system can generate a conditional vector field for the reverse iteration (808). In some implementations, generating a conditional vector field for the reverse iteration includes generating the conditional vector field based on the representation of the original image and the state of the editing process. More specifically, the system can determine a difference between the representation of the original image and the state of the editing process and divide the difference by a divisor that is based on the corresponding reverse time step.
The system can combine the conditional and unconditional vectors fields for the reverse iteration to generate a controlled vector field for the reverse iteration (810). In some implementations, combining the conditional and unconditional vector fields for the reverse iteration to generate a controlled vector field for the reverse iteration includes combining the conditional and unconditional vector fields for the reverse iteration in accordance with a controller guidance weight to generate the controlled vector field for the reverse iteration.
The system can update the state of the editing process using the controlled vector field for the reverse iteration (812). In some implementations, updating the state of the editing process using the controlled vector field for the editing iteration includes updating the state of the editing process using the controlled vector field for the reverse iteration and corresponding noise levels for the reverse iteration and a subsequent reverse iteration. More specifically, the system can determine a difference between the corresponding noise level for the subsequent reverse iteration and the corresponding noise level for the reverse iteration, determine a product of the controlled vector field and the difference and add the product to the state of the editing process.

In some implementations, the process 800 can further include updating the state of the editing process at each of one or more additional reverse iterations that are after the one or more reverse iterations, each additional reverse iteration having a corresponding additional reverse time step. The updating includes, at each additional reverse iteration, processing an input including the state of the editing process, a time step derived from the corresponding additional reverse time step for the additional reverse iteration, and the representation of the conditioning input using the rectified flow neural network to generate an unconditional vector field for the additional reverse iteration and updating the state of the editing process using the unconditional vector field for the additional reverse iteration. In some implementations, updating the state of the editing process using the unconditional vector field for the additional reverse iteration includes updating the state of the editing process using the unconditional vector field for the additional reverse iteration without generating a conditional vector field for the additional reverse iteration. In some implementations, different reverse iterations have different controller guidance weights.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining an original image and a conditioning input that specifies a modification to be applied to the original image;
performing an image inversion process on a representation of the original image using a rectified flow neural network to generate structured noise; and
performing an editing process using the rectified flow neural network and conditioned on the conditioning input to map the structured noise to a representation of a modified image.

2. The method of claim 1, wherein performing an image inversion process on a representation of the original image using a rectified flow neural network to generate structured noise comprises:
initializing a state of the image inversion process to be the representation of the original image; and
updating the state of the inversion process at each of a plurality of forward iterations, each forward iteration having a corresponding forward time step, and the updating comprising, at each forward iteration:
processing an input comprising the state of the inversion process and the corresponding forward time step for the forward iteration using the rectified flow neural network to generate an unconditional vector field for the forward iteration;
generating a conditional vector field for the forward iteration;
combining the conditional and unconditional vectors fields for the forward iteration to generate a controlled vector field for the forward iteration; and
updating the state of the inversion process using the controlled vector field for the forward iteration.

3. The method of claim 2, wherein the input comprising the state of the inversion process and the corresponding forward time step for the forward iteration further comprises a null representation that indicates that the unconditional vector field is not conditioned on a conditioning input.

4. The method of claim 2, wherein combining the conditional and unconditional vector fields for the forward iteration to generate a controlled vector field for the forward iteration comprises combining the conditional and unconditional vector fields for the forward iteration in accordance with a controller guidance weight to generate the controlled vector field for the forward iteration.

5. The method of claim 2, wherein updating the state of the inversion process using the controlled vector field for the forward iteration comprises:
updating the state of the inversion process using the controlled vector field for the forward iteration and corresponding noise levels for the forward iteration and a subsequent forward iteration.

6. The method of claim 5, wherein updating the state of the inversion process using the controlled vector field for the forward iteration and corresponding noise levels for the forward iteration and a subsequent forward iteration comprises:
determining a difference between the corresponding noise level for the subsequent forward iteration and the corresponding noise level for the forward iteration;
determining a product of the controlled vector field and the difference; and
adding the product to the state of the inversion process.

7. The method of claim 2, wherein generating a conditional vector field for the forward iteration comprises generating the conditional vector field based on a typical noise sample and the state of the inversion process.

8. The method of claim 7, wherein generating the conditional vector field based on a typical noise sample and the state of the inversion process comprises:
determining a difference between the typical noise sample and the state of the inversion process; and
dividing the difference by a divisor that is based on the corresponding forward time step.

9. The method of claim 1, wherein performing an editing process using the rectified flow neural network and conditioned on the conditioning input to map the structured noise to a representation of a modified image comprises:
initializing a state of the editing process to be the structured noise; and
updating the state of the editing process at each of a plurality of reverse iterations, each reverse iteration having a corresponding reverse time step, and the updating comprising, at each reverse iteration:
processing an input comprising the state of the editing process, a time step derived from the corresponding reverse time step for the reverse iteration, and a representation of the conditioning input using the rectified flow neural network to generate an unconditional vector field for the reverse iteration;
generating a conditional vector field for the reverse iteration;
combining the conditional and unconditional vector fields for the reverse iteration to generate a controlled vector field for the reverse iteration; and
updating the state of the editing process using the controlled vector field for the reverse iteration.

10. The method of claim 9, wherein the time step derived from the corresponding reverse time step for the reverse iteration is equal to one minus the corresponding reverse time step for the reverse iteration.

11. The method of claim 9, wherein the unconditional vector field for the reverse iteration is a negative of an output of the rectified flow neural network generated by processing the input comprising the state of the editing process, the time step derived from the corresponding reverse time step for the reverse iteration, and the representation of the conditioning input.

12. The method of claim 9, wherein combining the conditional and unconditional vector fields for the reverse iteration to generate a controlled vector field for the reverse iteration comprises combining the conditional and unconditional vector fields for the reverse iteration in accordance with a controller guidance weight to generate the controlled vector field for the reverse iteration.

13. The method of claim 9, wherein updating the state of the editing process using the controlled vector field for the reverse iteration comprises:
updating the state of the editing process using the controlled vector field for the reverse iteration and corresponding noise levels for the reverse iteration and a subsequent reverse iteration.

14. The method of claim 13, wherein updating the state of the editing process using the controlled vector field for the reverse iteration and corresponding noise levels for the reverse iteration and a subsequent reverse iteration comprises:
determining a difference between the corresponding noise level for the subsequent reverse iteration and the corresponding noise level for the reverse iteration;
determining a product of the controlled vector field and the difference; and
adding the product to the state of the editing process.

15. The method of claim 9, wherein generating a conditional vector field for the reverse iteration comprises generating the conditional vector field based on the representation of the original image and the state of the editing process.

16. The method of claim 15, wherein generating the conditional vector field based on the representation of the original image and the state of the editing process, comprises:
determining a difference between the representation of the original image and the state of the editing process; and
dividing the difference by a divisor that is based on the corresponding reverse time step.

17. The method of claim 9, wherein performing an editing process using the rectified flow neural network and conditioned on the conditioning input to map the structured noise to a representation of a modified image further comprises:
updating the state of the editing process at each of one or more additional reverse iterations that are after the plurality of reverse iterations, each additional reverse iteration having a corresponding additional reverse time step, and the updating comprising, at each additional reverse iteration:
processing an input comprising the state of the editing process, a time step derived from the corresponding additional reverse time step for the additional reverse iteration, and the representation of the conditioning input using the rectified flow neural network to generate an unconditional vector field for the additional reverse iteration; and
updating the state of the editing process using the unconditional vector field for the additional reverse iteration.

18. The method of claim 17, wherein updating the state of the editing process using the unconditional vector field for the additional reverse iteration comprises:
updating the state of the editing process using the unconditional vector field for the additional reverse iteration without generating a conditional vector field for the additional reverse iteration.

19. A system comprising:
one or more computers; and
one or more storage devices storing instructions that, when executed by the one or more computers, cause the one or more computers to perform operations comprising:
obtaining an original image and a conditioning input that specifies a modification to be applied to the original image;
performing an image inversion process on a representation of the original image using a rectified flow neural network to generate structured noise; and
performing an editing process using the rectified flow neural network and conditioned on the conditioning input to map the structured noise to a representation of a modified image.

20. One or more computer-readable storage media storing instructions that when executed by one or more computers cause the one or more computers to perform operations comprising:
obtaining an original image and a conditioning input that specifies a modification to be applied to the original image;
performing an image inversion process on a representation of the original image using a rectified flow neural network to generate structured noise; and
performing an editing process using the rectified flow neural network and conditioned on the conditioning input to map the structured noise to a representation of a modified image.
